(19) United States
(12) Patent Application Publication
(10) Pub. No.: US 2009/0213415 A1
(43) Pub. Date: Aug. 27, 2009

(54) DATA PROCESSING APPARATUS, DATA PROCESSING PROGRAM, DATA PROCESSING METHOD, SERVER, PROCESS EXECUTION INSTRUCTING PROGRAM, AND PROCESS EXECUTION INSTRUCTING METHOD

(75) Inventor: Toshiya SHOZAKI, Osaka-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/333,073

(22) Filed: Dec. 11, 2008

(30) Foreign Application Priority Data
Feb. 25, 2008 (JP) 2008-042873

(51) Int. Cl. G06K 15/10

(52) U.S. Cl. 358/1.15

(57) ABSTRACT

In order to execute a process using a result of a process executed in a server, an MFP includes: a browsing portion to receive a Web page from the server and cause the server to execute a process determined by the Web page based on an instruction input according to the Web page; a control information storing portion to accept control information upon reception of a setting command from the server, and store the control information in association with control identification information for identification of the control information; an identification information transmitting portion to transmit the control identification information to the server; and a process execution portion, upon reception of a job execution command from the server including the control identification information and the process execution result by the server, to execute a process based on the process execution result and the control information associated with the control identification information.

This application is based on Japanese Patent Application No. 2008-042873 filed with Japan Patent Office on Feb. 25, 2008, the entire content of which is hereby incorporated by reference.

### BACKGROUND OF THE INVENTION

1. Field of the Invention

The present invention relates to a data processing apparatus, a data processing program embodied on a computer readable medium, a data processing method, a server, a process execution instructing program embodied on a computer readable medium, and a process execution instructing method. More particularly, the present invention relates to a data processing apparatus capable of downloading a Web page from a server, a data processing program embodied on a computer readable medium and a data processing method each executed in the data processing apparatus, a server providing a Web service, and a process execution instructing program embodied on a computer readable medium and a process execution instructing method each executed in the Web server.

2. Description of the Related Art

A multi-function peripheral (hereinafter, referred to as the “MFP”) is capable of carrying out a variety of functions. However, certain functions cannot be combined together. When one of the functions that cannot be combined together is set, the other function is prohibited from being set, to prevent erroneous setting permitting execution of the functions that cannot be combined.

An address book having destinations of e-mails recorded thereon is advantageously managed by storing it in a server in a collective manner, rather than storing it in each of a plurality of MFPs. In this case, however, it is necessary to determine information of the destination from the address book stored in the server. For example, in the case of performing a process of transmitting data obtained by scanning an original in an MFP via e-mail, the destination can be determined only after the MFP acquires the address book from the server by downloading it or the like. This means that the program for acquiring the address book from the server needs to be installed onto both of the MFP and the server.

On the other hand, a technique of determining a processing condition on the server side is described in Japanese Patent Laid-Open No. 2005-208690 (Patent Document 1). Specifically, Japanese Patent Laid-Open No. 2005-208690 discloses a print system which retrieves, from a print conflict database, set items that should not be set in printing individual document data pieces at the submission of a plurality of document data pieces from among print setting instruction information, narrows down print appearance and bookbinding finishing setting information to be used, and instructs the default print setting of a print destination printer to be changed so as to be matched with the print setting instruction information.

With the conventional print system, however, the server is required to have the conflict database. In the case where different kinds of MFPs are connected, the conflict database should be generated for each of the MFPs, and if the functions of the connected MFPs are changed, the conflict databases should be changed as well. The need to change the conflict databases according to the changes in the connected MFPs makes the administration of the conflict databases troublesome.

### SUMMARY OF THE INVENTION

The present invention has been accomplished in view of the foregoing problems, and an object of the present invention is to provide a data processing apparatus capable of executing a process using a result of a process executed in a server.

Another object of the present invention is to provide a data processing program enabling execution of a process using a result of a process executed in a server.

A further object of the present invention is to provide a data processing method enabling execution of a process using a result of a process executed in a server.

A still further object of the present invention is to provide a server capable of causing an external apparatus to execute a process using a process result obtained by executing a process.

Yet another object of the present invention is to provide a process execution instructing program capable of causing an external apparatus to execute a process using a process result obtained through execution of a process.

Yet another object of the present invention is to provide a process execution instructing method capable of causing an external apparatus to execute a process using a process result obtained through execution of a process.

In order to achieve the above-described objects, according to an aspect of the present invention, a data processing apparatus includes: a browsing portion to receive a Web page from a server and cause the server to execute a process determined by the Web page based on an instruction input in accordance with the Web page; a control information storing portion to accept control information upon reception of a setting command from the server, and store the accepted control information in association with control identification information for identification of the control information; a control information transmitting portion to transmit the control identification information associated with the stored control information to the server; and a process execution portion, upon reception of a job execution command from the server including the control identification information and a result of execution by the server of the process determined by the Web page, to execute a process based on the result of execution of the process determined by the Web page and the control information associated with the control identification information.

According to another aspect of the present invention, a data processing program embodied on a computer readable medium causes a computer to execute processing including the steps of: receiving a Web page from a server and causing the server to execute a process determined by the Web page based on an instruction input in accordance with the Web page; accepting control information upon reception of a setting command from the server, and storing the accepted control information in association with control identification information for identification of the control information; transmitting the control identification information associated with the stored control information to the server; and upon reception of a job execution command from the server including the control identification information and a result of execution by the server of the process determined by the Web page, executing a process based on the result of execution of the process determined by the Web page and the control information associated with the control identification information.

According to a further aspect of the present invention, a data processing method causes a data processing apparatus to execute the steps of: receiving a Web page from a server and causing the server to execute a process determined by the Web page based on an instruction input in accordance with the Web page; accepting control information upon reception of a setting command from the server, and storing the accepted control information in association with control identification information for identification of the control information; transmitting the control identification information associated with the stored control information to the server; and upon reception of a job execution command from the server including the control identification information and a result of execution by the server of the process determined by the Web page, executing a process based on the result of execution of the process determined by the Web page and the control information associated with the control identification information.

According to a still further aspect of the present invention, a server includes: a substitute process execution portion to transmit a Web page in response to a request from an external apparatus, and execute a process determined by the Web page in response to reception of a process execution instruction from the external apparatus; a setting instructing portion to transmit a setting command to the external apparatus, to cause the external apparatus to set control information for use in execution of a prescribed process and transmit control identification information for identification of the set control information; an identification information receiving portion to receive the control identification information from the external apparatus in response to transmission of the setting command; and a command transmitting portion to transmit a job execution command including a result of execution of the process determined by the Web page and the control identification information to the external apparatus, to cause the external apparatus to execute a process using the result of execution of the process determined by the Web page and the control information.

According to yet another aspect of the present invention, a process execution instructing program embodied on a computer readable medium causes a computer to execute processing including the steps of: transmitting a Web page in response to a request from an external apparatus, and executing a process determined by the Web page in response to reception of a process execution instruction from the external apparatus; transmitting a setting command to the external apparatus, to cause the external apparatus to set control information for use in execution of a prescribed process and transmit control identification information for identification of the set control information; receiving the control identification information from the external apparatus in response to transmission of the setting command; and transmitting a job execution command including a result of execution of the process determined by the Web page and the control identification information to the external apparatus, to cause the external apparatus to execute a process using the result of execution of the process determined by the Web page and the control information.

According to yet another aspect of the present invention, a process execution instructing method causes a server to execute the steps of: transmitting a Web page in response to a request from an external apparatus, and executing a process determined by the Web page in response to reception of a process execution instruction from the external apparatus; transmitting a setting command to the external apparatus, to cause the external apparatus to set control information for use in execution of a prescribed process and transmit control identification information for identification of the set control information; receiving the control identification information from the external apparatus in response to transmission of the setting command; and transmitting a job execution command including a result of execution of the process determined by the Web page and the control identification information to the external apparatus, to cause the external apparatus to execute a process using the result of execution of the process determined by the Web page and the control information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a print system according to an embodiment of the present invention.

FIG. 2 is a perspective view of an MFP.

FIG. 3 is a block diagram showing an example of the hardware configuration of the MFP.

FIG. 4 is a block diagram showing an example of the hardware configuration of a server.

FIG. 5 is a functional block diagram schematically showing the functions of a CPU provided in the MFP together with data stored in an EEPROM.

FIG. 6 shows an example of display of a print condition setting screen.

FIG. 7 shows an example of the format of control information.

FIG. 8 is a functional block diagram showing the functions of a CPU 201 provided in the server together with data stored in an HDD.

FIG. 9 shows an example of an authentication screen.

FIG. 10 is a flowchart illustrating an example of the flow of Web application processing.

FIG. 11 is a flowchart illustrating an example of the flow of control information setting processing.

FIG. 12 is a flowchart illustrating an example of the flow of job execution processing.

FIGS. 13 and 14 are flowcharts illustrating an example of the flow of Web service processing.

### DESCRIPTION OF THE PREFERRED EMBODIMENTS

Embodiments of the present invention will now be described with reference to the drawings. In the following description, like reference characters denote like parts, which have like names and functions, and therefore, detailed description thereof will not be repeated.

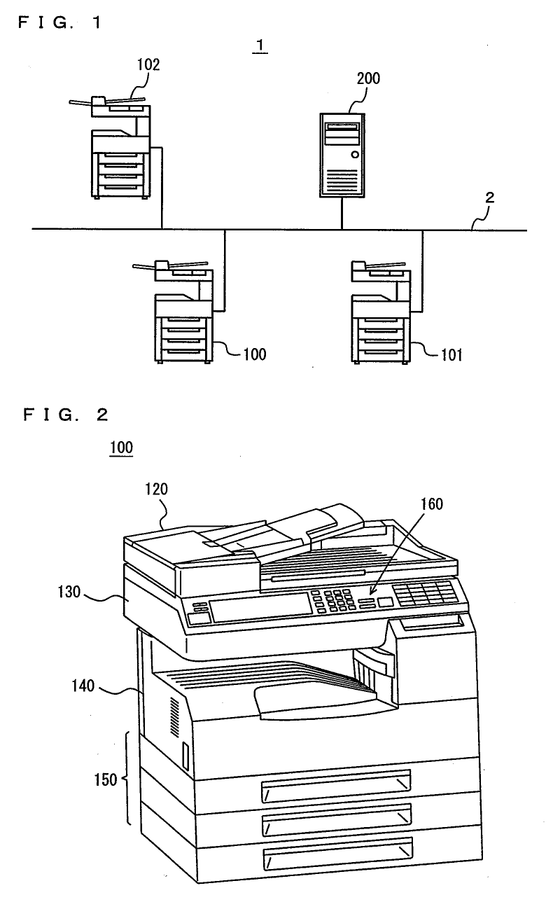

FIG. 1 schematically shows a print system according to an embodiment of the present invention. Referring to FIG. 1, a print system 1 includes MFPs 100, 101 and 102, each serving as a data processing apparatus, and a server 200, which are connected to a network 2.

Network 2 is a local area network (LAN), which is connected to the Internet via a gateway. Network 2 may be connected in a wired or wireless manner. Further, not limited to the LAN, network 2 may be a network using public switched telephone networks, a wide area network (WAN), the Internet, or the like.

Server 200 is a typical computer, which is installed with an application program functioning as a file sever and a Web server. Thus, server 200 provides a predetermined Web service. The application program for providing the Web service is generated based on the API (Application Program Interface) disclosed by the manufacturers of MFPs 100, 101 and 102. Server 200 transmits commands to MFPs 100, 101 and 102 using a communication protocol of SOAP (Simple Object Access Protocol), for example, to control the respective MFPs 100, 101 and 102.

MFPs 100, 101 and 102 each include a scanner for reading an original, an image forming device for forming an image on a recording medium such as a sheet of paper based on image data, and a facsimile machine, and have an image reading function, copying function, and facsimile transmitting/receiving function. Each of MFPs 100, 101 and 102 is installed with a typical browsing program, and is capable of receiving a Web service from server 200 functioning as the Web server.

Here, it is assumed that server 200 provides a Web service for setting a job of printing the data stored in server 200 in any of MFPs 100, 101 and 102. In this case, server 200 transmits a print condition setting screen as a Web page.

It is noted that the Web service may also be the one for setting a job of outputting data from any of MFPs 100, 101 and 102 using the data, e.g. an address book, stored in server 200.

While MFPs 100, 101 and 102 are described by way of example in the present embodiment, the data processing apparatus is not limited to MFPs 100, 101 and 102, but may be any device having the function of processing an image, such as a printer, facsimile machine, and the like. Further, it may be a computer installed with a printer driver for controlling the respective MFPs 100, 101 and 102. MFPs 100, 101 and 102 are identical in function, and thus, MFP 100 will be explained representatively in the following, unless otherwise stated.

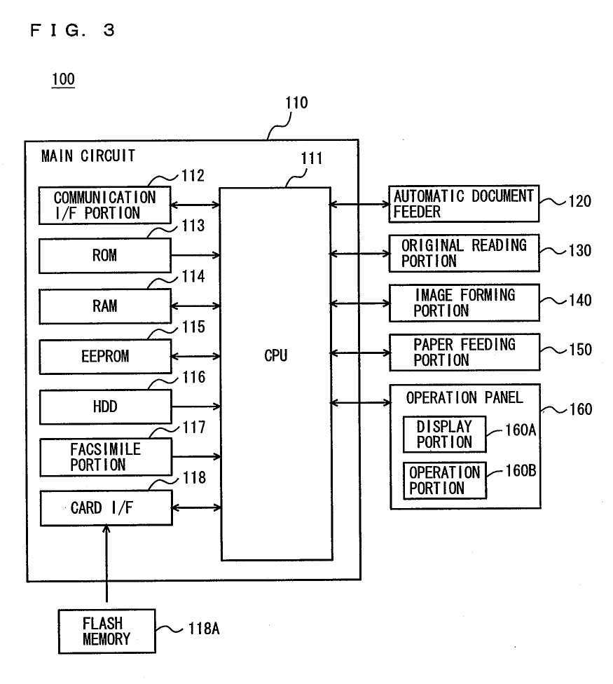

FIG. 2 is a perspective view of the MFP, and FIG. 3 is a block diagram showing an example of the hardware configuration of the MFP. Referring to FIGS. 2 and 3, MFP 100 includes: a main circuit 110; an original reading portion 130 which reads an original; an automatic document feeder 120 which delivers an original to original reading portion 130; an image forming portion 140 which forms, on a sheet of paper or the like, a still image output from original reading portion 130 that read an original; a paper feeding portion 150 which supplies sheets of paper to image forming portion 140; and an operation panel 160 serving as a user interface. Main circuit 110 includes a central processing unit (CPU) 111, a communication interface (I/F) portion 112, a ROM (Read Only Memory) 113, a RAM (Random Access Memory) 114, an EEPROM (Electronically Erasable and Programmable ROM) 115, a hard disk drive (HDD) 116 as a mass storage, a facsimile portion 117, and a card interface (I/F) 118 mounted with a flash memory 118A. CPU 111 is connected with automatic document feeder 120, original reading portion 130, image forming portion 140, paper feeding portion 150, and operation panel 160, and is responsible for overall control of MFP 100.

ROM 113 stores a program executed by CPU 111 or data necessary for execution of the program. RAM 114 is used as a work area when CPU 111 executes a program. Further, RAM 114 temporarily stores still images continuously transmitted from original reading portion 130.

Operation panel 160 is provided on an upper surface of MFP 100, and includes a display portion 160A and an operation portion 160B. Display portion 160A is a display such as a liquid crystal display (LCD), an organic electro-luminescence display (ELD) or the like, and displays an instruction menu for the user, information about acquired image data, and others. Operation portion 160B is provided with a plurality of keys, and accepts input of data such as instructions, characters and numerical characters, according to the key operations of the user. Operation portion 160B further includes a touch panel provided on display portion 160A.

Communication I/F portion 112 is an interface for connecting MFP 100 to network 2. CPU 111 communicates with MFP 101, MFP 102, or server 200 via communication I/F portion 112, for transmission/reception of data. Further, communication I/F portion 112 is capable of communicating with a computer connected to the Internet via network 2. Further, communication I/F portion 112 transmits/receives e-mails to/from a PC.

Facsimile portion 117 is connected to public switched telephone networks (PSTN), and transmits facsimile data to or receives facsimile data from the PSTN. Facsimile portion 117 stores the received facsimile data in HDD 116, or outputs it to image forming portion 140. Image forming portion 140 prints the facsimile data received from facsimile portion 117 on a sheet of paper. Further, facsimile portion 117 converts the image data output from original reading portion 130 that read an original or the data stored in HDD 116 to facsimile data, and transmits the facsimile data to a facsimile machine connected to the PSTN.

Card I/F 118 is mounted with flash memory 118A. CPU 111 is capable of accessing flash memory 118A via card I/F 118. CPU 111 loads a program recorded on flash memory 118A mounted to card I/F 118, to RAM 114 for execution. It is noted that the program executed by CPU 111 is not restricted to the program recorded on flash memory 118A. CPU 111 may load a program stored in HDD 116 to RAM 114 for execution. In this case, another computer connected to network 2 may rewrite the program stored in HDD 116 of MFP 100 or may additionally write a new program. Further, MFP 100 may download a program from another computer connected to network 2, and store the program in HDD 116. As used herein, the “program” includes, not only the program directly executable by CPU 111, but also a source program, a compressed program, an encrypted program, and others.

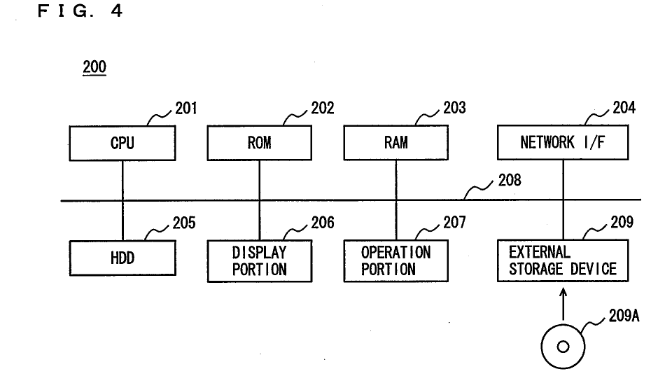

FIG. 4 is a block diagram showing an example of the hardware configuration of the server. Referring to FIG. 4, server 200 includes: a CPU 201 which is responsible for overall control of server 200; a ROM 202 which stores a program executed by CPU 201 and the like; a RAM 203 used as a work area for CPU 201; a network I/F 204 which connects server 200 to network 2; an HDD 205 as a mass storage; a display portion 206; an operation portion 207 which accepts an input of a user's operation; and an external storage device 209; which are connected to a bus 208.

External storage device 209 is mounted with a CD-ROM 209A which stores a process execution instructing program. CPU 201 loads the process execution instructing program stored in CD-ROM 209A via external storage device 209, to RAM 203 for execution. It is noted that the recording medium for storing the process execution instructing program is not restricted to CD-ROM 209A. It may be a flexible disk, a cassette tape, an optical disc (CD-ROM (Compact Disc-ROM), MO (Magnetic Optical Disc), MD (Mini Disc), DVD (Digital Versatile Disc)), an IC card, an optical card, or a semiconductor memory such as a masked ROM, an EPROM (Erasable Programmable ROM), an EEPROM (Electronically EPROM), or the like. Alternatively, the program stored in HDD 205 may be loaded to RAM 203 for execution. In this case, server 200 may download a program from another computer connected to network 2 and store it in HDD 205. As used herein, the “program” includes, not only the program directly executable by CPU 201, but also a source program, a compressed program, an encrypted program, and others.

Server 200 functions as a file server. Here, it is assumed that HDD 205 stores an address book and a plurality of pieces of shared data.

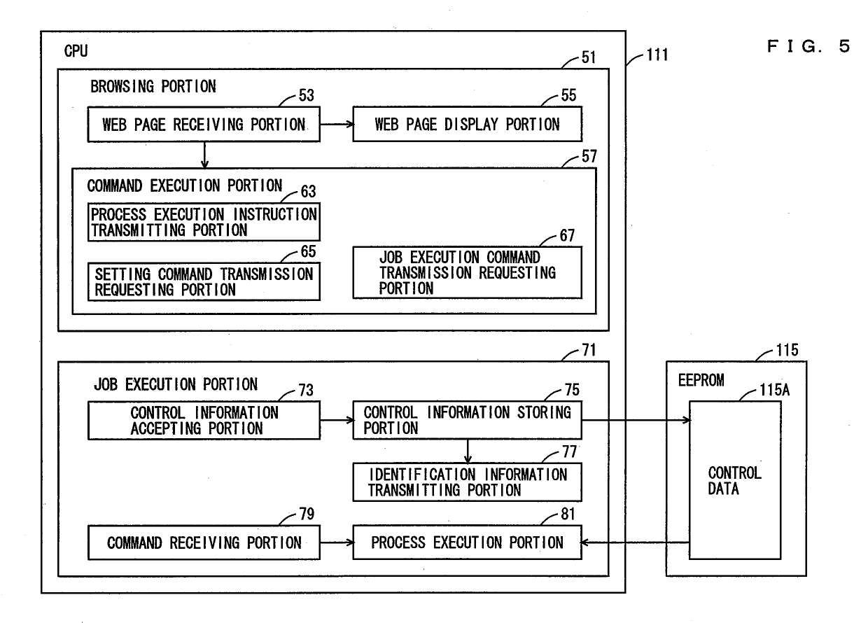

FIG. 5 is a functional block diagram schematically showing the functions of the CPU provided in the MFP, together with data stored in the EEPROM. Referring to FIG. 5, CPU 111 includes a browsing portion 51 established by execution of a browsing program, and a job execution portion 71.

Browsing portion 51 includes a Web page receiving portion 53 to receive a Web page, a Web page display portion 55 to display the received Web page, and a command execution portion 57 to execute a command included in the Web page. Web page receiving portion 53 transmits a transmission request requesting transmission of a Web page to server 200 via communication I/F portion 112. Server 200, in receipt of the transmission request, transmits the Web page specified by the transmission request. When communication I/F portion 112 receives the Web page from server 200, Web page receiving portion 53 acquires the Web page from communication I/F portion 112.

Here, one of the buttons provided in operation portion 160B is pre-assigned a command for calling the Web service provided by server 200. This command is for transmitting a transmission request requesting transmission of a Web page to server 200, and includes a URL of the Web page. The command is, e.g., a GET command or a POST command transmitted using a communication protocol of HTTP. When the user inputs an operation to designate the button assigned the command, Web page receiving portion 53 executes the command assigned to the designated button to transmit the transmission request requesting transmission of the Web page via communication I/F portion 112 to server 200, and acquires the Web page that communication I/F portion 112 receives from server 200.

Web page receiving portion 53 outputs the received Web page to Web page display portion 55, which in turn displays the Web page on display portion 160A. If the received Web page contains a command, Web page receiving portion 53 outputs the command extracted from the Web page to command execution portion 57.

Command execution portion 57 executes the command input from Web page receiving portion 53. Here, it is assumed that the Web page contains a print condition setting screen, including a first command to transmit a process execution instruction to server 200, a second command to request server 200 to transmit a setting command, and a third command to request server 200 to transmit a job execution command. When Web page receiving portion 53 receives the Web page, the first through third commands are input to command execution portion 57. This establishes the following in command execution portion 57: a process execution instruction transmitting portion 63 for execution of the first command; a setting command transmission requesting portion 65 for execution of the second command; and a job execution command transmission requesting portion 67 for execution of the third command. While the functions formed in command execution portion 57 when Web page receiving portion 53 receives a Web page containing a print condition setting screen are explained here, the functions formed in command execution portion 57 vary depending on the commands included in the Web page received by Web page receiving portion 53.

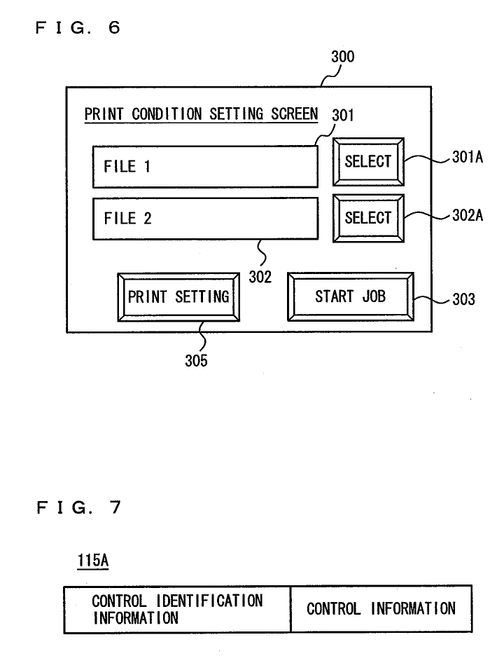

FIG. 6 shows a display example of the print condition setting screen. Referring to FIG. 6, a print condition setting screen 300 includes: fields 301 and 302 for inputting file names; buttons 301A and 302A corresponding to fields 301 and 302, respectively, and each having the characters “SELECT” displayed thereon; a button 305 having “PRINT SETTING” displayed thereon; and a button 303 having “START JOB” displayed thereon.

Buttons 301A and 302A are associated with the first command, button 305 is associated with the second command, and button 303 is associated with the third command. While print condition setting screen 300 in this example has two fields 301 and 302 for inputting the file names, the number of fields for inputting the file names may be any number at least one.

Returning to FIG. 5, when a file name is input to field 301 or 302 on print condition setting screen 300, CPU 111 executes the first command. This causes process execution instruction transmitting portion 63 to accept the input file name. The file name input to field 301 or 302 is the file name of the data stored in HDD 116 of MFP 100 or HDD 205 of server 200. The file name may be input to field 301 or 302 directly. Alternatively, another Web page containing a list of file names of the data stored in HDD 116 of MFP 100 or HDD 205 of server 200 may be received and the file name selected from the list may be input.

When the user designates button 301A or 302A on print condition setting screen 300, process execution instruction transmitting portion 63 transmits a process execution instruction to server 200, to cause server 200 to execute a process of selecting the file name input to the corresponding field 301 or 302. The process execution instruction includes the file name input to field 301 or 302. In receipt of the process execution instruction, server 200 executes the process in accordance with the process execution instruction, to select the file name included in the process execution instruction. Specifically, upon designation of button 301A, the process execution instruction including the file name input to field 301 is transmitted to server 200, while upon designation of button 302A, the process execution instruction including the file name input to field 302 is transmitted to server 200.

When the user designates button 305 on print condition setting screen 300, CPU 111 executes the second command. This causes setting command transmission requesting portion 65 to transmit a setting command transmission request to server 200, to cause server 200 to transmit a setting command. The setting command will be described later.

When the user designates button 303 on print condition setting screen 300, CPU 111 executes the third command. This causes job execution command transmission requesting portion 67 to transmit a job execution command transmission request to server 200, to cause server 200 to transmit a job execution command. The job execution command transmission request will be described later.

Job execution portion 71 includes: a control information accepting portion 73 to accept control information; a control information storing portion 75 to assign control identification information to the control information and store them in association with each other; an identification information transmitting portion 77 to transmit the control identification information assigned to the control information to server 200; a command receiving portion 79 to receive a command from server 200; and a process execution portion 81 to execute a process in accordance with a job execution command.

When setting command transmission requesting portion 65 described above transmits a setting command transmission request to server 200, server 200 transmits a setting command to designate setting of control information. Control information accepting portion 73 controls communication I/F portion 112 to receive the setting command transmitted from server 200. When job execution command transmission requesting portion 67 described above transmits a job execution command transmission request to server 200, server 200 transmits a job execution command. In receipt of the job execution command from server 200, command receiving portion 79 outputs it to process execution portion 81. The job execution command includes: a result of the process executed by server 200 in receipt of and in accordance with the process execution instruction described above; and the control identification information.

In receipt of a setting command from server 200, control information accepting portion 73 accepts a set value for use in executing a function provided by MFP 100. While MFP 100 is capable of executing a plurality of functions, the setting command received from server 200 determines which set value for executing which function is to be accepted. Here, it is assumed that the setting command designates the set value for executing the function of setting a print condition. In this case, control information accepting portion 73 displays a setting screen for setting print conditions on display portion 160A, and accepts the set values input by the user to operation portion 160B as the control information. Since the set values for executing the functions provided in MFP 100 are accepted as the control information, even in the case where a certain set value is not allowed to be set in combination with another set value, MFP 100 can prevent setting of the set values in such a combination. This eliminates the need to store the combination of the set values that cannot be set together in any place other than MFP 100. Control information accepting portion 73 outputs the accepted control information to control information storing portion 75.

Control information storing portion 75 assigns, to the control information input from control information accepting portion 73, control identification information for identification of the same. It outputs the control identification information to identification information transmitting portion 77, and stores control data, having the control identification information and the control information associated with each other, in EEPROM 115. In this manner, control data 115A is stored in EEPROM 115.

FIG. 7 shows an example of the format of the control data. Referring to FIG. 7, control data 115A includes control identification information and control information. One piece of control data 115A is stored every time the control information is set.

Returning to FIG. 5, identification information transmitting portion 77 transmits the control identification information received from control information storing portion 75 to server 200 via communication I/F portion 112.

When a job execution command is input from command receiving portion 79, process execution portion 81 reads a piece of control data 115A stored in EEPROM 115 that includes the control identification information included in the job execution command, and acquires the control information included in the read piece of control data 115A. Then, process execution portion 81 executes a process according to a result of execution of the process by server 200 in accordance with the process execution instruction, which is included in the job execution command, and also according to the acquired control information. As will be described later, the result of execution of the process by server 200 in accordance with the process execution instruction, which is included in the job execution command received from server 200, is a result of the process that server 200 has carried out in receipt of the process execution instruction transmitted by process execution instruction transmitting portion 63, which here is a result of the process of selecting the file name included in the process execution instruction. Thus, the job execution command includes the file name selected by server 200. Consequently, process execution portion 81 acquires the data specified by the file name included in the job execution command, and performs printing according to the set value for the printing indicated by the control information included in the job execution command. This allows the data of the file name selected by server 200 to be printed under the print conditions that can be set in MFP 100.

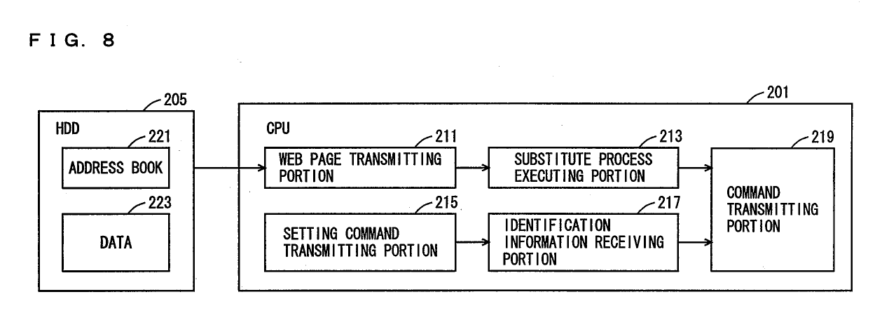

FIG. 8 is a functional block diagram showing the functions of CPU 201 provided in the server, together with the data stored in the HDD. Referring to FIG. 8, CPU 201 includes: a Web page transmitting portion 211 to transmit a Web page in response to a request; a substitute process execution portion 213 to execute a prescribed process; a setting command transmitting portion 215 to transmit a setting command for designating setting of control information; an identification information receiving portion 217 to receive control identification information; and a command transmitting portion 219 to transmit a job execution command.

HDD 205 prestores an address book 221 and data 223. Address book 221 and data 223 are shared, and accessible by a plurality of users.

When network I/F 204 receives a transmission request from MFP 100 requesting transmission of a Web page, Web page transmitting portion 211 reads the Web page specified by the URL included in the transmission request from HDD 205, and transmits the Web page via network I/F 204. Here, since MFP 100 transmits the transmission request requesting transmission of the Web page containing the print condition setting screen shown in FIG. 6, Web page transmitting portion 211 transmits the Web page containing the print condition setting screen shown in FIG. 6. After transmitting the Web page containing print condition setting screen 300 to MFP 100, Web page transmitting portion 211 informs substitute process execution portion 213 to that effect.

The Web page may include identification information for identification of a record included in address book 221 or data 223 stored in HDD 205, or may include process identification information for identification of the process that can be executed by server 200. Here, the Web page containing print condition setting screen 300 is associated with the process of selecting a file name, and thus, the Web page preferably includes the file name of data 223. Further, in the case where the Web page includes the record included in address book 221, the Web page is associated with the process of selecting the record included in address book 221. Alternatively, if the Web page is configured to include process identification information for specifying the process that can be executed by server 200, the Web page may be associated with the process specified by the process identification information.

In the present embodiment, server 200 authorizes users so as to restrict the users who receive the Web service. Thus, in receipt of the transmission request requesting transmission of the print condition setting screen, server 200 transmits a Web page containing an authentication screen for requesting login, prior to transmission of the Web page containing print condition setting screen 300.

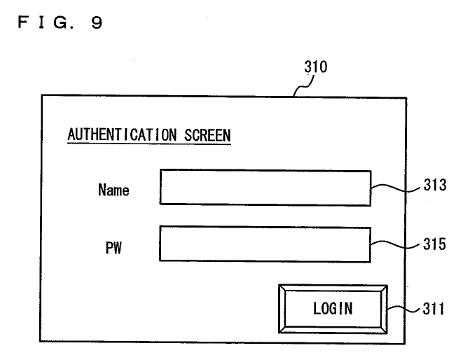

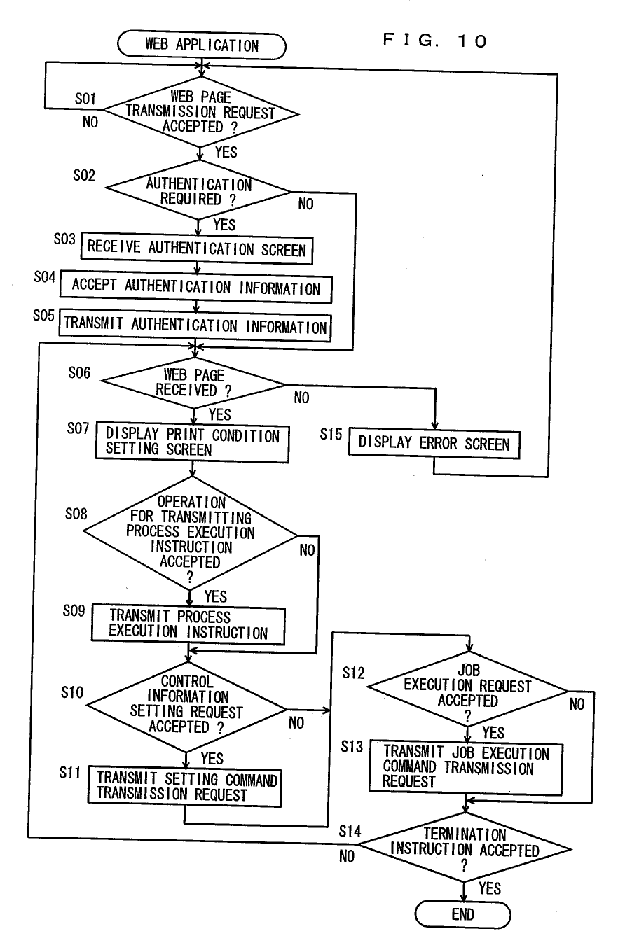

FIG. 9 shows an example of the authentication screen. Referring to FIG. 9, an authentication screen 310 includes a field 313 for inputting user identification information, a field 315 for inputting a password, and a button 311 having the characters “LOGIN” displayed thereon. The authentication screen includes a command for accepting the user identification information and password, and a command for transmitting the accepted user identification information and password to server 200. When the user identification information and password are input to the respective fields 313 and 315, the command is executed to accept them. The command for transmitting the user identification information and password to server 200 is associated with the button 311. Upon designation of button 311, the command is executed to transmit the accepted user identification information and password to server 200.

Returning to FIG. 5, in CPU 111 provided in MFP 100, when Web page receiving portion 53 receives the authentication screen, the command to accept the user identification information and password and the command to transmit the accepted user identification information and password to server 200 are input to command execution portion 57. Command execution portion 57 executes the commands to accept the user identification information and password and transmit the accepted user identification information and password to server 200. Then, in server 200, it is determined whether the set of user identification information and password received from MFP 100 is prestored, and if so, server 200 determines that the user corresponding to the user identification information is authorized, and transmits the Web page containing the print condition setting screen to MFP 100.

Returning to FIG. 8, substitute process execution portion 213 controls network I/F 204 to receive the process execution instruction transmitted from MFP 100, and executes the process in accordance with the process execution instruction. Since the process execution instruction in this example defines the process of selecting the file name included therein, substitute process execution portion 213 selects the file name. Further, upon reception of the process execution instruction, substitute process execution portion 213 acquires session identification information for identification of the communication session being established with MFP 100. Substitute process execution portion 213 then outputs a set of the result of execution of the process by substitute process execution portion 213 according to the process execution instruction (hereinafter, referred to as a “process execution result”) and the acquired session identification information, to command transmitting portion 219. Here, the process execution result includes the file name selected. It is noted that in the case where the Web page transmitted by Web page transmitting portion 211 is associated with the process of selecting a destination address for the e-mail transmitting process or file transferring process from among the addresses included in address book 221 stored in HDD 205, the process execution result includes the address included in the process execution instruction. Further, in the case where the Web page transmitted by Web page transmitting portion 211 is associated with the process of executing prescribed image processing, the process execution result includes the data after execution of the image processing by server 200 or the file name for identification of the data.

When setting command transmitting portion 215 controls network I/F 204 to receive a setting command transmission request transmitted from MFP 100, it transmits a setting command that instructs setting of control information, via network I/F 204 to MFP 100 that issued the setting command transmission request. Here, setting command transmitting portion 215 transmits the setting command according to the communication protocol of SOAP.

MFP 100 that received the setting command transmits control identification information for identification of control information when the control information is set, as described above. Identification information receiving portion 217 controls network I/F 204 to receive the control identification information transmitted from MFP 100. Further, identification information receiving portion 217 acquires session identification information for identification of the communication session being established with MFP 100 when receiving the control identification information. It then outputs the set of the received control identification information and the acquired session identification information to command transmitting portion 219.

Command transmitting portion 219 receives the set of the process execution result and the session identification information from substitute process execution portion 213, and receives the set of the control identification information and the session identification information from identification information receiving portion 217. Command transmitting portion 219 controls network I/F 204 to receive the job execution command transmission request transmitted from MFP 100. Further, command transmitting portion 219 acquires session identification information for identification of the communication session being established with MFP 100 that transmitted the job execution command transmission request when receiving the job execution command transmission request. It then generates a job execution command which includes the process execution result and the control identification information each making a pair with the acquired session identification information. Further, it transmits the generated job execution command via network I/F 204 to MFP 100 that issued the job execution command transmission request. Here, command transmitting portion 219 transmits the job execution command according to the communication protocol of SOAP. The job execution command includes the control identification information and a result of the process executed according to the process execution instruction that was received during the time when the communication session having the same session identification information as that of the communication session established upon reception of that control identification information was established. This allows the file name selected in MFP 100 to be associated with the control information set in MFP 100, for each Web page containing the print condition setting screen being transmitted.

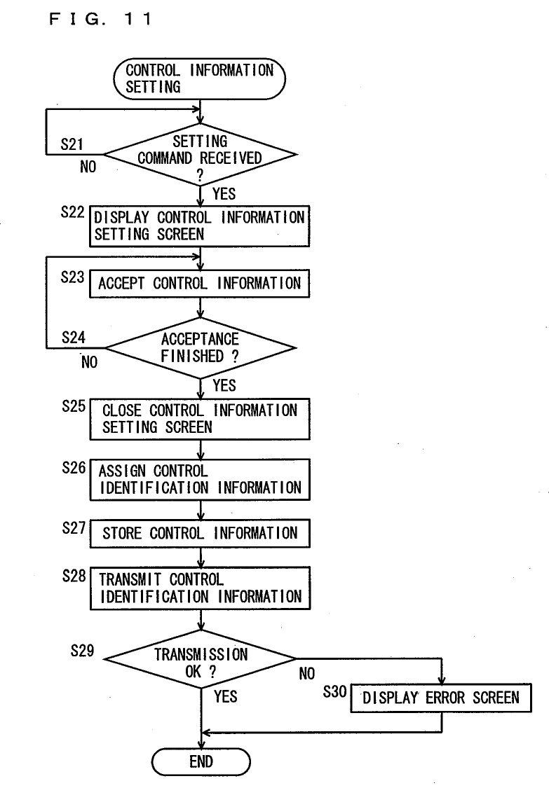

FIG. 10 is a flowchart illustrating an example of the flow of Web application processing. The Web application processing is carried out by CPU 111 provided in MFP 100 as CPU 111 executes the data processing program. Referring to FIG. 10, CPU 111 determines whether a request for transmission of a Web page has been accepted. CPU 111 is in a standby mode until it accepts the Web page transmission request (NO in step S01), and once it accepts the request (YES in step S01), it executes a browsing program and moves the process to step S02. Here, the Web page transmission request is accepted upon detection of the user's operation to designate one of the buttons provided in operation portion 160B which is pre-assigned a command for requesting transmission of the Web page containing the print condition setting screen. The command for requesting transmission of the Web page containing the print condition setting screen is a command for transmitting a transmission request to server 200. The command includes the URL of the Web page containing the print condition setting screen, and is a GET command or POST command transmitted according to the communication protocol of HTTP.

In step S02, it is determined whether authentication is necessary. If so, the process proceeds to step S03; otherwise, the process proceeds to step S06. Whether the authentication is necessary is determined according to the Web service provided by server 200. Need or no-need for authentication may be registered in advance in MFP 100 in association with the URL of the Web page containing the print condition setting screen. In step S03, CPU 111 receives the Web page containing the authentication screen shown in FIG. 9. It accepts the authentication information (step S04), and transmits the accepted authentication information to server 200 (step S05). Here, the authentication information includes user identification information and a password. The processing in steps S04 and S05 is carried out by CPU 111 as it executes the commands included in the Web page containing the authentication screen.

While the case of receiving the Web page containing the authentication screen from server 200 has been described above, CPU 111 in MFP 100 may display the authentication screen on display portion 160A, and accept authentication information input by the user and transmit the accepted authentication information to server 200. Further, the authentication information that was used for authentication upon login of the user to MFP 100 may be transmitted to server 200. In this case, it is unnecessary to display the authentication screen again after an input of the user's operation to designate the button pre-assigned the command for requesting transmission of the Web page containing the print condition setting screen.

In step S06, it is determined whether the Web page containing the print condition setting screen has been received from server 200. Specifically, it is determined whether communication I/F portion 112 has received the Web page containing the print condition setting screen from server 200. If so, the process proceeds to step S07; otherwise, the process proceeds to step S15.

In step S15, an error screen is displayed on display portion 160A, and the process returns to step S01. The error screen is received upon failure of authentication by server 200 based on the authentication information transmitted in step S05.

In step S07, the print condition setting screen included in the received Web page is displayed on display portion 160A. In the following step S08, it is determined whether an operation of transmitting a process execution instruction has been accepted. If the operation of transmitting the process execution instruction is accepted, the process proceeds to step S09; otherwise, the process proceeds to step S10, with step S09 skipped. Here, the operation of transmitting the process execution instruction corresponds to an input of file name to either field 301 or 302 and designation of either button 301A or 302A on the print condition setting screen. When the operation of designating either button 301A or 302A is detected, it is determined that the file name has been accepted, and the process proceeds to step S09. In step S09, the process execution instruction including the accepted file name is transmitted to server 200.

In step S10, it is determined whether a request for setting control information has been accepted. If the request for setting the control information is accepted, the process proceeds to step S11; otherwise, the process proceeds to step S12, with step S11 skipped. When the operation of designating button 305 on print condition setting screen 300 is detected, it is determined that the request for setting the control information has been accepted. In step S11, a setting command transmission request is transmitted to server 200. The steps S10 and S11 are carried out as CPU 111 executes the second command that is included in print condition setting screen 300 and associated with button 305.

In step S12, it is determined whether a job execution request has been accepted. If the job execution request is accepted, the process proceeds to step S13; otherwise, the process proceeds to step S14, with step S13 skipped. When the operation of designating button 303 on print condition setting screen 300 is detected, it is determined that the job execution request has been accepted. In step S13, a job execution command transmission request is transmitted to server 200. The steps S12 and S13 are carried out as CPU 111 executes the third command that is included in print condition setting screen 300 and associated with button 303.

In step S14, it is determined whether a termination instruction has been accepted. If so, the process is terminated; otherwise, the process returns to step S06. When the operation of closing print condition setting screen 300 displayed on display portion 160A in step S07 is detected, the termination instruction is accepted. Upon acceptance of the termination instruction, the communication session being established with server 200 is disconnected.

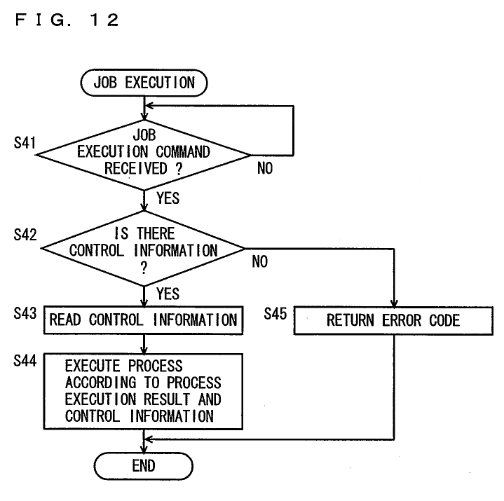

FIG. 11 is a flowchart illustrating an example of the flow of control information setting processing. The control information setting processing is carried out by CPU 111 provided in MFP 100 as CPU 111 executes the data processing program. It is carried out in parallel with the Web application processing described above. Referring to FIG. 11, CPU 111 determines whether a setting command has been received (step S21). CPU 111 is in a standby mode until communication I/F portion 112 receives a setting command from server 200, and once it receives the setting command (YES in step S21), CPU 111 moves the process to step S22. That is, the processing in and after step S22 is carried out on the condition that the setting command is received from server 200. The setting command is the command which the server 200 transmits in response to reception of the setting command transmission request transmitted to server 200 in step S11 in FIG. 10.

In step S22, a control information setting screen is displayed on display portion 160A. Here, the control information setting screen is the screen for setting the print conditions. A setting value input by the user to operation portion 160B according to the setting screen for setting the print conditions is accepted as the control information (step S23). Then, it is determined whether the acceptance of the control information has been finished (step S24). For example, when designation of the button provided on the screen for setting the print conditions that is associated with the instruction to finish the setting is detected, it is determined that the acceptance of the control information is completed. The control information is accepted in step S23 continuously until completion of acceptance of the control information. When the acceptance of the control information is finished, the process proceeds to step S25.

In step S25, the control information setting screen is closed, and the process proceeds to step S26. In step S26, the control information accepted in step S23 is assigned control identification information for identification of the control information. In the following step S27, the control information accepted in step S23 is stored in EEPROM 115 in association with the control identification information assigned thereto in step S26. Further, in step S28, the control identification information assigned is transmitted to server 200. In the followings step S29, it is determined whether transmission has succeeded. If the transmission is successful, the process is terminated; otherwise, the process proceeds to step S30. In step S30, an error screen is displayed on display portion 160A, and the process is terminated.

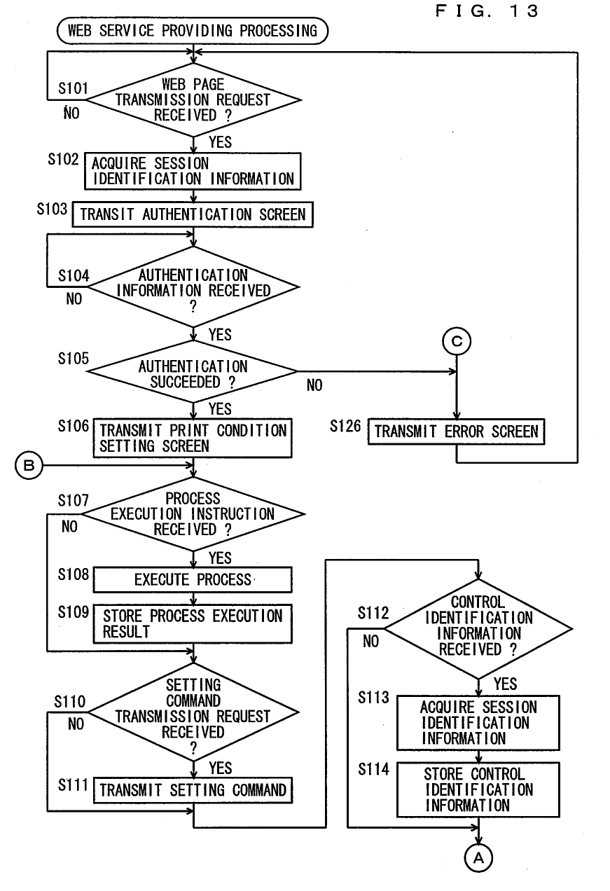

FIG. 12 is a flowchart illustrating an example of the flow of job execution processing. The job execution processing is carried out by CPU 111 provided in MFP 100 as CPU 111 executes the data processing program. It is carried out in parallel with the Web application processing described above. Referring to FIG. 12, CPU 111 determines whether a job execution command has been received (step S41). CPU 111 is in a standby mode until communication I/F portion 112 receives a job execution command from server 200 (NO in step S41), and once the job execution command is received (YES in step S41), CPU 111 moves the process to step S42. That is, the processing in and after step S42 is carried out on the condition that the job execution command is received from server 200. The job execution command is the command which the server 200 transmits in response to reception of the job execution command transmission request transmitted to server 200 in step S13 in FIG. 10. The job execution command includes: the result (process execution result) of the process executed by server 200 that received the process execution instruction transmitted in step S09 in FIG. 10, in accordance with that process execution instruction; and the control identification information transmitted to server 200 in step S28 in the control information setting processing illustrated in FIG. 11.

In step S42, it is determined whether there is control information. If the control information associated with the control identification information included in the received job execution command is stored in EEPROM 115, it is determined that there is the control information. If there is the control information, the process proceeds to step S43; otherwise, the process proceeds to step S45. In step S45, an error code is returned to server 200, and the process is terminated.

In step S43, the control information is read from EEPROM 115. Then, processing is carried out (step S44) in accordance with the process execution result included in the job execution command received in step S41 and the control information read in step S43, and the process is terminated. Here, the process execution result is the file name and the control information is the set value for printing, and thus in step S44, the data specified by the file name is printed in accordance with the set value.

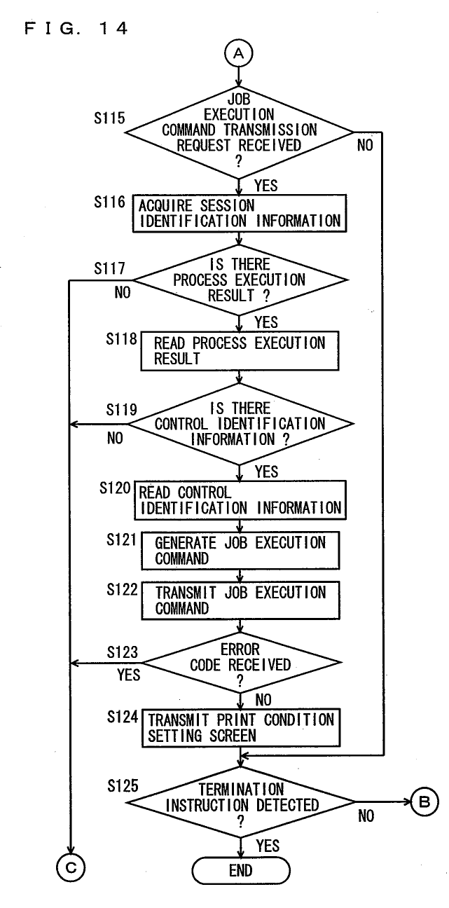

FIGS. 13 and 14 are flowcharts illustrating an example of the flow of Web service providing processing. The Web service providing processing is carried out by CPU 201 provided in server 200 as CPU 201 executes the process execution instructing program. Referring to FIGS. 13 and 14, CPU 201 determines whether a request for transmission of a Web page has been received (step S101). CPU 201 is in a standby mode until network I/F 204 receives the Web page transmission request from one of MFPs 100, 101 and 102 (NO in step S101), and once the Web page transmission request is received, CPU 201 moves the process to step S102. That is, the processing in and after step S102 is carried out on the condition that the Web page transmission request is received from one of MFPs 100, 101 and 102. Here, the case of receiving the Web page transmission request from MFP 100 will be described by way of example.

In step S102, the session identification information for identification of the communication session established with MFP 100 that transmitted the Web page transmission request is acquired. The session identification information may be provided by server 200. In step S103, the Web page containing the authentication screen shown in FIG. 9 is transmitted to MFP 100. CPU 201 is in a standby mode until reception of the authentication information (NO in step S104), and once it receives the authentication information, it moves the process to step S105.

In step S105, authentication is performed based on the received authentication information, and it is determined whether the authentication has succeeded. Here, the authentication information corresponds to the user identification information and the password. Server 200 prestores the sets of user identification information and passwords of the users permitted to receive the Web service. It is determined whether the set of user identification information and password received from MFP 100 is stored in advance, and if the set is prestored, the user corresponding to the user identification information is authenticated; otherwise, the user is not authenticated. If the authentication is successful, the process proceeds to step S106; otherwise, the process proceeds to step S126. In step S126, a Web page containing an error screen is transmitted to MFP 100, and the process returns to step S101.

In step S106, the Web page containing print condition setting screen 300 shown in FIG. 6 is transmitted to MFP 100. It is then determined whether a process execution instruction has been received (step S107). If the process execution instruction is received, the process proceeds to step S108; otherwise, the process proceeds to step S110. In step S108, a process is executed based on the received process execution instruction. The result of execution of the process is temporarily stored (step S109). Here, the process execution instruction includes the instruction to execute the process of selecting the file name, and therefore, the process of selecting the file name is executed, and the selected file name is temporarily stored as the process execution result.

In step S110, it is determined whether a setting command transmission request has been received. Specifically, it is determined whether network I/F 204 has received a setting command transmission request from MFP 100. If the setting command transmission request is received, the process proceeds to step S111; otherwise, the process proceeds to step S112, with step S111 skipped. In step S111, a setting command is transmitted to MFP 100 that issued the setting command transmission request.

In step S112, it is determined whether control identification information has been received. Specifically, it is determined whether network I/F 204 has received the control identification information transmitted from MFP 100 that issued the setting command transmission request. If the control identification information is received, the process proceeds to step S113; otherwise, the process proceeds to step S115. In step S113, session identification information for identification of the communication session being established with MFP 100 that transmitted the control identification information is acquired. Then, the control identification information received in step S112 is temporarily stored in association with the session identification information (step S114).

In the following step S115, it is determined whether a job execution command transmission request has been received. Specifically, it is determined whether network I/F 204 has received a job execution command transmission request transmitted from MFP 100. If the job execution command transmission request is received, the process proceeds to step S116; otherwise, the process proceeds to step S125. In step S116, session identification information for identification of the communication session being established with MFP 100 that transmitted the job execution command transmission request is acquired.

In the following step S117, it is determined whether there is a process execution result that makes a pair with the session identification information acquired in step S116. Specifically, it is determined whether the process execution results temporarily stored in step S109 includes the process execution result associated with the session identification information acquired in step S116. If there is such a process execution result, the process proceeds to step S118; otherwise, the process proceeds to step S126. In step S118, the process execution result associated with the session identification information acquired in step S116 is read, and the process proceeds to step S119.

In step S119, it is determined whether there is control identification information that makes a pair with the session identification information acquired in step S116. Specifically, it is determined whether the control identification information temporarily stored in step S114 includes the control identification information associated with the session identification information acquired in step S116. If there is such control identification information, the process proceeds to step S120; otherwise, the process proceeds to step S126. In step S120, the control identification information associated with the session identification information acquired in step S116 is read, and the process proceeds to step S121.

In step S121, a job execution command including the process execution result read in step S118 and the control identification information read in step S120 is generated. The generated job execution command is transmitted via network I/F 204 to MFP 100 that issued the job execution command transmission request received in step S115 (step S122). The job execution command includes: the process execution result; and the control identification information received when the communication session having the session identification information the same as that of the communication session established when receiving the process execution instruction based on which the process execution result was obtained has been established. This enables the result of the process MFP 100 caused server 200 to execute and the control information set in MFP 100 to be associated with each other, for each Web page containing the print condition setting screen transmitted from server 200.

In MFP 100 that receives the job execution command, a process is executed in accordance with the job execution command. However, if the control information associated with the control identification information included in the job execution command is not stored, for example, execution of the process fails. Upon failure of execution of the process, an error code is transmitted.

In step S123, it is determined whether an error code has been received from MFP 100 to which the job execution command was transmitted. Specifically, it is determined whether network I/F 204 has received the error code transmitted from MFP 100. If the error code is received, the process proceeds to step S126; otherwise, the process proceeds to step S124. In step S124, the Web page containing the print condition setting screen is transmitted to MFP 100, and the process proceeds to step S125. In step S126, an error screen is transmitted, and the process returns to step S101.

In step S125, it is determined whether a termination instruction has been detected. When disconnection of the communication session established with MFP 100 that issued the Web page transmission request received in step S101 is detected, the termination instruction is detected. Upon detection of the termination instruction, the process is terminated; otherwise, the process returns to step S107.

As described above, in print system 1 according to the present embodiment, the browsing program is executed in MFP 100. When a file name is selected in print condition setting screen 300 transmitted from server 200, a process execution instruction is transmitted to server 200 to cause it to execute the process of selecting the file name. The process is executed in server 200 according to the process execution instruction, and the process execution result is stored, which here is the file name included in the process execution instruction. In this case, the browsing program is executed in MFP 100, and thus, CPU 111 provided in MFP 100 cannot recognize selection of the file name. On the contrary, in server 200, the file name is recognized.

In MFP 100, the control information such as the set value for printing is accepted and stored in EEPROM 115 in association with control identification information. The control identification information is also transmitted to server 200. Even if MFP 100 has a plurality of functions, the control information is set in MFP 100. Thus, it is possible to prevent, e.g., setting of the set values that cannot be combined together.

Further, in MFP 100, upon reception of the job execution command from server 200 including the process execution result and the control identification information, a process is executed based on the process execution result and the control information. This enables execution of the process using the result of the process executed in server 200. Further, it is only necessary to execute the browsing program in MFP 100, without the need of development or installation of a special program.

Further, in the server, even if MFPs 100, 101 and 102 have different functions, it is unnecessary to develop or install programs for the respective MFPs 100, 101 and 102. It is also unnecessary to store a prohibition rule table defining the set values that cannot be combined together and the like, for each of MFPs 100, 101 and 102.

While print system 1 has been described in the above embodiment, the present invention may of course be understood as a data processing method for executing Web application processing shown in FIGS. 10-12 or a data processing program for causing a computer to execute the data processing method, or a process execution instructing method for executing Web service providing processing shown in FIGS. 13 and 14 or a process execution instructing program for causing a computer to execute the process execution instructing method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data processing apparatus comprising:
a browsing portion to receive a Web page from a server and cause said server to execute a process determined by said Web page based on an instruction input in accordance with said Web page;
a control information storing portion to accept control information upon reception of a setting command from said server, and store said accepted control information in association with control identification information for identification of said control information;
a control information transmitting portion to transmit said control identification information associated with said stored control information to said server; and
a process execution portion, upon reception of a job execution command from said server including said control identification information and a result of execution by said server of the process determined by said Web page, to execute a process based on the result of execution of the process determined by said Web page and said control information associated with said control identification information.

2. The data processing apparatus according to claim 1, wherein said browsing portion includes a process execution instructing portion to execute a first command included in said received Web page to transmit a process execution instruction to said server to cause said server to execute the process determined by said Web page.

3. The data processing apparatus according to claim 1, wherein said browsing portion includes a setting command transmission requesting portion to execute a second command included in said Web page to transmit a setting command transmission request to said server to request transmission of said setting command from said server.

4. The data processing apparatus according to claim 1, wherein said browsing portion includes a a job execution command transmission requesting portion to execute a third command included in said Web page to transmit a job execution command transmission request to said server to request transmission of said job execution command from said server.

5. A data processing program embodied on a computer readable medium and causing a computer to execute processing including the steps of:
receiving a Web page from a server and causing said server to execute a process determined by said Web page based on an instruction input in accordance with said Web page;
accepting control information upon reception of a setting command from said server, and storing said accepted control information in association with control identification information for identification of said control information;
transmitting said control identification information associated with said stored control information to said server; and
upon reception of a job execution command from said server including said control identification information and a result of execution by said server of the process determined by said Web page, executing a process based on the result of execution of the process determined by said Web page and said control information associated with said control identification information.

6. The data processing program according to claim 5, wherein said step of causing said server to execute a process includes the step of executing a first command included in said received Web page to transmit a process execution instruction to said server to cause said server to execute the process determined by said Web page.

7. The data processing program according to claim 5, wherein said step of causing said server to execute a process includes the step of executing a second command included in said Web page to transmit a setting command transmission request to said server to request transmission of said setting command from said server.

8. The data processing program according to claim 5, wherein said step of causing said server to execute a process includes the step of executing a third command included in said Web page to transmit a job execution command transmission request to said server to request transmission of said job execution command from said server.

9. A data processing method executed by a data processing apparatus, comprising the steps of:
receiving a Web page from a server and causing said server to execute a process determined by said Web page based on an instruction input in accordance with said Web page;
accepting control information upon reception of a setting command from said server, and storing said accepted control information in association with control identification information for identification of said control information;
transmitting said control identification information associated with said stored control information to said server; and
upon reception of a job execution command from said server including said control identification information and a result of execution by said server of the process determined by said Web page, executing a process based on the result of execution of the process determined by said Web page and said control information associated with said control identification information.

10. A server comprising:
a substitute process execution portion to transmit a Web page in response to a request from an external apparatus, and execute a process determined by said Web page in response to reception of a process execution instruction from said external apparatus;
a setting instructing portion to transmit a setting command to said external apparatus, to cause said external apparatus to set control information for use in execution of a prescribed process and transmit control identification information for identification of the set control information;
an identification information receiving portion to receive said control identification information from said external apparatus in response to transmission of said setting command; and
a command transmitting portion to transmit a job execution command including a result of execution of the process determined by said Web page and said control identification information to said external apparatus, to cause said external apparatus to execute a process using the result of execution of the process determined by said Web page and said control information.

11. The server according to claim 10, further comprising a session acquiring portion to acquire session identification information for identification of a communication session established with said external apparatus, wherein
said command transmitting portion transmits said control identification information and the result of the process determined by said Web page which was executed based on the process execution instruction that was received from said external apparatus during the time when a communication session having the same session identification information as that of the communication session established when receiving the control identification information was established.

12. The server according to claim 10, wherein
said Web page includes a second command to transmit a setting command transmission request requesting transmission of said setting command, and
said setting instructing portion transmits said setting command in response to reception of said setting command transmission request from said external apparatus that executes said second command.

13. The server according to claim 10, wherein
said Web page includes a third command to transmit a job execution command transmission request requesting transmission of said job execution command, and
said command transmitting portion transmits said job execution command in response to reception of said job execution command transmission request from said external apparatus that executes said third command.

14. A process execution instructing program embodied on a computer readable medium and causing a computer to execute processing including the steps of:
transmitting a Web page in response to a request from an external apparatus, and executing a process determined by said Web page in response to reception of a process execution instruction from said external apparatus;
transmitting a setting command to said external apparatus, to cause said external apparatus to set control information for use in execution of a prescribed process and transmit control identification information for identification of the set control information;
receiving said control identification information from said external apparatus in response to transmission of said setting command; and
transmitting a job execution command including a result of execution of the process determined by said Web page and said control identification information to said external apparatus, to cause said external apparatus to execute a process using the result of execution of the process determined by said Web page and said control information.

15. The process execution instructing program according to claim 14, causing said computer to further execute the step of acquiring session identification information for identification of a communication session established with said external apparatus, wherein
said step of transmitting the job execution command further includes the step of generating the job execution command including said control identification information and the result of the process determined by said Web page which was executed based on the process execution instruction that was received from said external apparatus during the time when a communication session having the same session identification information as that of the communication session established when receiving the control identification information was established.

16. The process execution instructing program according to claim 14, wherein
said Web page includes a second command to transmit a setting command transmission request requesting transmission of said setting command, and
said step of transmitting the setting command includes the step of transmitting said setting command in response to reception of said setting command transmission request from said external apparatus that executes said second command.

17. The process execution instructing program according to claim 14, wherein
said Web page includes a third command to transmit a job execution command transmission request requesting transmission of said job execution command, and
said step of transmitting the job execution command includes the step of transmitting said job execution command in response to reception of said job execution command transmission request from said external apparatus that executes said third command.

18. A process execution instructing method executed by a server, comprising the steps of:
transmitting a Web page in response to a request from an external apparatus, and executing a process determined by said Web page in response to reception of a process execution instruction from said external apparatus;
transmitting a setting command to said external apparatus, to cause said external apparatus to set control information for use in execution of a prescribed process and transmit control identification information for identification of the set control information;
receiving said control identification information from said external apparatus in response to transmission of said setting command; and
transmitting a job execution command including a result of execution of the process determined by said Web page and said control identification information to said external apparatus, to cause said external apparatus to execute a process using the result of execution of the process determined by said Web page and said control information.
